(19) United States
(12) Patent Application Publication
(10) Pub. No.: US 2026/0156117 A1
(43) Pub. Date: Jun. 4, 2026

(54) PRIVATE NETWORK ACCESS CONTROL USING GRANTS

(71) Applicant: Tailscale Inc., Toronto (CA)

(72) Inventors: Maisem J. Ali, Woodinville, WA (US); Bradley J. Fitzpatrick, Seattle, WA (US)

(21) Appl. No.: 19/406,123

(22) Filed: Dec. 2, 2025

Related U.S. Application Data
(60) Provisional application No. 63/726,862, filed on Dec. 2, 2024.

(51) Int. Cl. H04L 9/40

(52) U.S. Cl. CPC H04L 63/101; H04L 63/0236

(57) ABSTRACT

The technology disclosed herein enables grant-based control of communication traffic over a private network. In a particular example, a method includes receiving a grant at a destination node of the nodes from a policy engine for the private network. The grant indicates a list of sources and a list of destinations sources in the sources are allowed to access. The method further includes caching the grant in a cache at the destination node. Additionally, the method includes receiving one or more packets over the private network from a source node. The one or more packets are directed towards an application executing on the destination node. In response to accessing the grant from the cache to determine the source node is in the list of sources and the destination node is in the list of destinations, the method provides passing the one or more packets to the application.

### RELATED APPLICATION

This application is related to and claims priority to U.S. Provisional Patent Application 63/726,862, titled “PRIVATE NETWORK ACCESS CONTROL USING GRANTS,” filed December 2, 2024, and which is hereby incorporated by reference in its entirety.

### BACKGROUND

Modern enterprises increasingly depend on private networking technologies to secure communications between distributed systems. These networks often span multiple environments—such as on-premises infrastructure, cloud platforms, and remote endpoints—and must maintain confidentiality and integrity across potentially untrusted underlying transport layers. To achieve this, organizations commonly implement identity-based access controls and encrypted tunnels, ensuring that only authenticated nodes can exchange data within the private network.

While authentication establishes trust at the point of entry, ongoing communication between nodes introduces additional considerations. Nodes may need to interact with specific services or applications hosted within the network, and these interactions often require granular authorization beyond simple network connectivity. Conventional approaches to enforcing such policies typically rely on static configurations or centralized rule sets, which can become cumbersome in dynamic environments where devices, users, and workloads frequently change. These complexities can influence how permissions are defined, distributed, and enforced across diverse layers of the network stack.

### SUMMARY

The technology disclosed herein enables grant-based control of communication traffic over a private network. In a particular example, a method includes receiving a grant at a destination node of the nodes from a policy engine for the private network. The grant indicates a list of sources and a list of destinations sources in the list of sources are allowed to access. The method further includes caching the grant in a cache at the destination node. Additionally, the method includes receiving one or more packets over the private network from a source node. The one or more packets are directed towards an application executing on the destination node. In response to accessing the grant from the cache to determine the source node is in the list of sources and the destination node is in the list of destinations, the method provides passing the one or more packets to the application.

In another example, another method includes retrieving definitions for access grants. The access grants provide permissions allowing nodes of the private network to communicate with others of the nodes specified by the access grants. The method also includes providing the access grants to the nodes and, in the nodes, allowing communication exchanges over the private network between the nodes when permitted by the access grants.

In a further example, an apparatus is provided having a one or more computer readable storage media and a processing system operatively coupled with the one or more computer readable storage media. Program instructions stored on the one or more computer readable storage media, when read and executed by the processing system, direct the apparatus to execute a client for communicating over the private network and receive access grants from a coordination service of the private network. The access grants define allowed characteristics of communications permitted over the private network. The program instructions also direct the apparatus to identify private-network traffic, allow a first portion of the private-network traffic having first characteristics of the allowed characteristics, and deny a second portion of the private-network traffic having second characteristics absent from the first characteristics.

### BRIEF DESCRIPTION OF THE DRAWINGS

FIGS. 1 illustrates an implementation for using grants to control access on a private network.

FIG. 2 illustrates an operation that uses grants to control access on a private network.

FIG. 3 illustrates an operational scenario for using grants to control access on a private network.

FIG. 4 illustrates an implementation for using grants to control access on a private network.

FIG. 5 illustrates an operational scenario for using grants to control access on a private network.

FIG. 6 illustrates an operational scenario for using grants to control access on a private network.

FIG. 7 illustrates an operational scenario for using grants to control access on a private network.

FIG. 8 illustrates an operational scenario for using grants to control access on a private network.

FIG. 9 illustrates an access grant for controlling access on a private network.

FIG. 10 illustrates an operation that uses grants to control access on a private network.

FIG. 11 illustrates a computing system for using grants to control access on a private network.

### DETAILED DESCRIPTION

A private overlay network is a network built on top of an existing physical network infrastructure (e.g., network interfaces, routers, switches, links, etc.), but with a virtual layer that creates a private and secure communication environment between devices. In an overlay network, connected devices (often referred to as nodes of the private network) can communicate as if they were on a dedicated, isolated physical network, even though they are using a public or shared underlying network. This may be achieved through software-defined networking (SDN) and protocols that allow for greater flexibility, security, and control over the communication traffic that flows between the nodes. Overlay networks are commonly used in virtual private networks (VPNs), distributed systems, and cloud environments to segment traffic, ensuring privacy and performance despite the underlying network's potential vulnerabilities.

Packet encapsulation is a key feature enabling a private overlay network. When data is sent from one node to another within the overlay, the original data packet (often called the payload) is “wrapped” within another, outer packet. This outer packet is constructed according to the rules of the overlay network's protocol, allowing it to be transmitted securely across the public network or the physical infrastructure. For instance, the original data packet may include a header directing the packet to a network address of a device on the private network. Encapsulating the original packet may encrypt the original packet using keys known only to nodes on the private network and then adding a new packet header directing the encrypted data to a public network address for the device. The encapsulation serves two purposes: it provides a secure tunnel for the data, ensuring that the packet can travel without being intercepted or altered by unauthorized entities, and it abstracts the details of the underlying physical network, enabling the overlay network to operate independently of it. Once the packet reaches the destination node, the encapsulation is removed (e.g., the encapsulated packet header is removed and the data is decrypted), and the original payload is processed.

To ensure secure communication and prevent unauthorized access, devices joining the private overlay network must authenticate themselves as valid nodes. This authentication process typically involves using cryptographic techniques, such as digital certificates or pre-shared keys, to verify the identity of each node before it can participate in the overlay. In some cases, a public key infrastructure (PKI) may be used, where each node has a unique cryptographic key pair (public and private keys) to prove its identity to other nodes on the network. In some examples, an Identity Provider (IDP) may be responsible for validating user identities and providing the necessary credentials or tokens for users to access protected systems and services. Once authenticated, nodes can encapsulate and exchange data packets for the private network.

The nodes described herein leverage the authentication already provided by the private network to regulate the nodes’ ability to access resources over the private network. The resources may include access to other nodes, access to applications or services on those nodes, or some other type of network accessible computing resource. A destination node can determine the identity of a source node for received packets based on the source nodes authentication to the private network (e.g., the source node may be associated with a particular user that was authenticated by the private network). The destination node can then determine whether the source node is allowed to send packets to the destination node and/or is allowed to access a resource on the destination node. In this case, a policy engine distributes grants to the nodes defining the access afforded to certain nodes. A node can refer to the grants to determine whether packet traffic is allowed. Neither the node nor a resource thereon need perform any additional authentication to determine whether access is allowed.

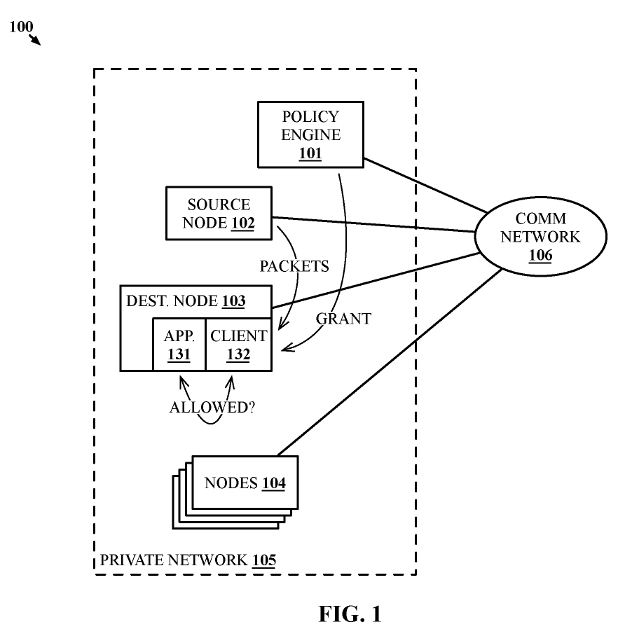

FIGS. 1 illustrates implementation 100 for using grants to control access on a private network. Implementation 100 includes policy engine 101, source node 102, destination node 103, nodes 104, and communication network 106. Policy engine 101 and nodes 102-104 communicate with each other over private network 105. Private network 105 is a private network, such as a Virtual Private Network (VPN) or a physical private network, that uses an authentication mechanism, such as an IDP, to ensure computing devices connected to private network 105 are authorized to join private network 105. Private network 105 is an overlay network on physical networking hardware, such wired/wireless communication links, routers, switches, firewalls, computing devices, or other type of components for providing network communications between computing systems. In some examples, at least a portion of the physical networking hardware is included in, or underlies a portion of, communication network 106. Communication network 106 may include one or more local area networks, wide area networks (e.g., the Internet), or some other type of network.

In operation, users of computing devices (e.g., personal computers, laptops, smartphones, tablets, servers, virtual machines, or other type of computing devices – including combinations thereof) authenticate themselves to private network 105 enabling the computing devices to connect to private network 105 as nodes 102-104 and exchange communications with each other over private network 105. Policy engine 101 may be a dedicated computing system, or virtualized computing system, or may be a component of another computing system, such as a coordination system for private network 105. Private network 105 may leverage an external system, such as an IDP, to authenticate users, may use an internal authentication mechanism, or may use some other mechanism for ensuring a computing device is associated with a user authorized to access private network 105. Devices of users that are unable to authenticate themselves to private network 105 (or are otherwise not allowed to access private network 105) are not allowed to join private network 105 as nodes to private network 105. While shown within private network 105, is part of the control plane for private network 105. Thus, policy engine 101 is not necessarily executing on a node connected to private network 105. In some examples, the control plane of private network 105 may be implemented by a coordination service that includes policy engine 101. The coordination service may function as the control plane for multiple private networks, including private network 105.

In cases where private network 105 is a VPN, an overlay network is achieved through a process called encapsulation, where the data packets sent between devices are wrapped inside additional packets that include encrypted information. For instance, when a VPN endpoint device (e.g., device of nodes 103-104) sends data through a VPN, a packet carrying the data is encrypted and then encapsulated with a new packet header that includes a public IP address of another VPN endpoint device as the destination. This encapsulated packet is then sent over a public network to the destination VPN endpoint device.

At the destination VPN endpoint device, the outer packet header is stripped away to reveal the original encrypted packet. The original packet is then decrypted, allowing the data to be processed by the device. In some examples, the VPN endpoint device may be a VPN server operating as a gateway to the public network. In those examples, the decrypted original packet may be transmitted to a destination IP address on the public network identified in a header of the original packet. The above encryption method ensures that the data remains confidential and secure as it travels over potentially insecure networks, as only the VPN destination endpoint can decrypt and access the original information. By creating a secure tunnel through encryption and encapsulation, VPNs effectively simulate a private network over a public infrastructure, providing privacy and security for users. As such, a communication received by a node over the VPN can be trusted to have been sent by another node authorized to access the VPN.

In this example, nodes 102-104 execute clients thereon to handle communications over private network 105. Private network client 132 is the instance of the clients executing on destination node 103. The clients may handle an authentication process for authenticating each of nodes 102-104 to connect to private network 105, encryption and encapsulation of packets for transmission over private network 105, decryption and decapsulation of packets received over private network 105, and may perform some other action for connecting to and communicating over private network 105.

Private network 105 uses grants distributed by policy engine 101 to perform access control with resources therein. Grants allow users or groups to be assigned specific permissions to access particular resources or networks. These permissions can be created and managed through an administrative interface into policy engine 101 or automated using an Application Programming Interface (API) for private network 105. User grants may assign permissions to individual users and group grants may apply to user groups, making it easier to manage access for multiple people at once. Grants may work in conjunction with Access Control Lists (ACLs), which define specific access policies, ensuring that only authorized users or groups can access certain devices or subnets. Grants can be revoked at any time, allowing administrators to easily remove access when necessary. Advantageously, the syntax used to define a grant is shared between network layer and application layer capabilities. Each grant only requires a source and a destination, at least for network layer access. Private network 105 uses a deny-by-default approach enabling each grant to have an implied accept action. Other private networks may use different approaches requiring additional information in the grant. A grant may further include a listing of applications (or other resources) that are also allowed for the source and destinations listed therein, which enables a grant to apply at the application layer.

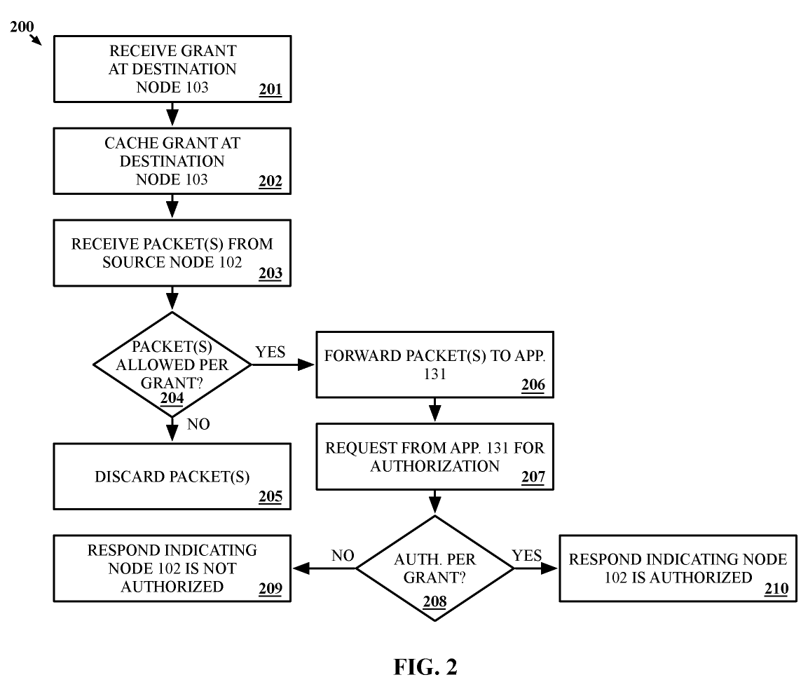

FIG. 2 illustrates operation 200 that uses grants to control access on a private network. Operation 200 is described from the perspective of destination node 103. Source node 102 and destination node 103 are referred to as such due to being the source and destination of packets in this example. Any of nodes 102-104 may be a source and destination of packets exchanged over private network 105. In operation 200, destination node 103 receives a grant from policy engine 101 (step 201). The grant may be drafted by a user, such as an administrator of private network 105, or may be autogenerated in the syntax used for grants by private network 105 to implement a policy for private network 105. The grant may be received individually or may be received along with one or more other grants. Upon receipt, destination node 103 caches the grant locally thereat (step 202). In this example, private network client 132 handles the receipt and caching of the grant at destination node 103 but another component executing on destination node 103 may handle the steps in other examples.

After receiving and caching the grant, one or more packets are received at destination node 103 from source node 102 (step 203). Since private network client 132 handles the communications exchanged over private network 105 for destination node 103, private network client 132 processes the received packets to determine whether the grant cached at destination node 103 applies to the packets (step 204). The grant at least lists one or more sources and one or more destinations allowed for packets but may also list one or more ports and/or one or more protocols that are allowed to be used between the identified sources and destinations. The sources and destinations may be identified in the grant using device identifiers (e.g., network addresses) for nodes or some other type of identifier, such as a user or group of users associated with a node. For instance, “User A” may be identified as a source in the grant. All nodes associated with User A (e.g., all nodes that are authenticated for access to private network 105 using User A’s credentials) would, therefore, be considered a source within the context of the grant. A controller for private network 105 may distribute information about user-node associations so that private network client 132 can determine whether packets are receives from User A’s nodes. If the grant does not indicate the packets are allowed, private network client 132 discards the packets (Step 205). In this example, if the packets are allowed, then private network client 132 forwards the packets to application 131, which is the application to which the packets are directed (step 206).

After forwarding the packets, private network client 132 receives a request for authorization from application 131 (step 207). The packets themselves may carry a request to access application 131 or may be some other type of communication with application 131. Up to this point, private network client 132 has used the network-layer portion of the grant. Although, in this example, the grant also defines application-layer authorizations. Specifically, the grant includes application 131 in a list of one or more applications, services, and/or other application-layer resources to which the allowed sources have access. Upon receiving the request from application 131, private network client 132 determines whether the grant indicates source node 102 is authorized to access application 131 (step 208). If the grant does not list application 131 as being accessible by source node 102, then private network client 132 responds to the request from application 131 with an indication that source node 102 is not allowed access to application 131 (step 209). Application 131 may simply discard or ignore the communications in the packets or may respond to source node 102 with a message indicating that source node 102 is not authorized to access application 131. In some examples, the grant may specify allowed ports (e.g., TCP port 443 for HTTPS) or protocols (e.g., ICMP for diagnostics). Private network client 132 may inspect packet headers to confirm compliance with these characteristics before transmission or forwarding.

If, however, the grant indicates to private network client 132 that source node 102 can access application 131, then application 131 responds to the request from application 131 indicating that source node 102 is authorized to access application 131 (step 210). Application 131 may then handle the information in the packets as application 131 is configured to do. For instance, if the packets carried a request for a particular feature of application 131, then application 131 may provide the feature to source node 102 over private network 105. Application 131 may request authorization from private network client 132 each time a packet is received from source node 102, periodically when packets are received (e.g., once an hour), just a first time packets are received for a given session, or on some other schedule. Advantageously, application 131 does not need to authenticate source node 102 but, rather, relies on the grants provided by policy engine 101 and the fact that source node 102 had to authenticate with private network 105 to gain access to private network 105.

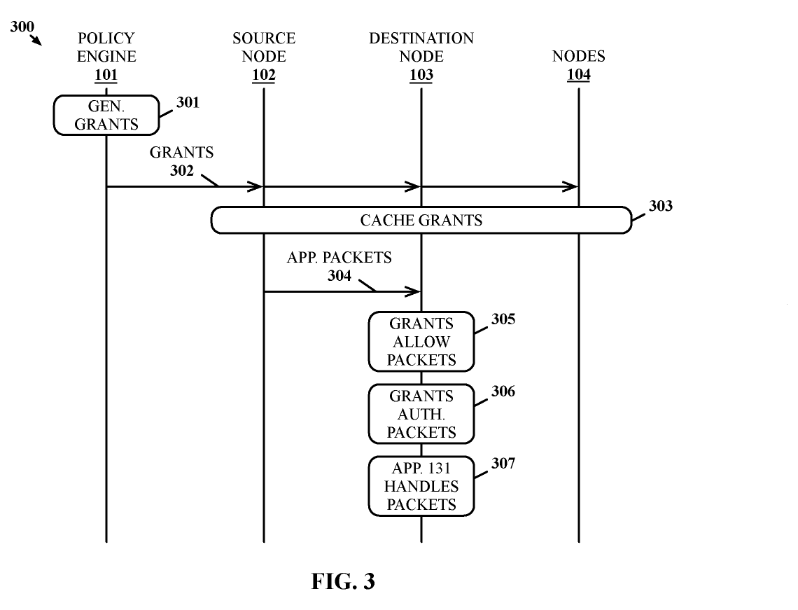

FIG. 3 illustrates operational scenario 300 for using grants to control access on a private network. In operational scenario 300, policy engine 101 generates grants to control access on private network 105 (step 301). A portion of the grants define network-layer access allowances (e.g., which nodes can communicate with which other nodes) and a portion of the grants define application-layer access allowances (e.g., which applications/services can be accessed by which nodes/users). The grants may be generated at substantially the same time or may be generated as policies change for private network 105. For instance, an administrator of private network 105 may decide to change access policies over time (e.g., may decide a given group of users should have access to a certain application that they did not previously have access). The administrator may script the grant themselves of may rely on an automated grant creation mechanism to create the grant from the desired policy. Grants created by policy engine 101 for private network 105 are distributed to all of nodes 102-104 over private network 105 (step 302). In other examples, there may be certain grants that are not relevant to certain nodes and policy engine 101 may choose not to distribute the non-relevant grants to those nodes. Upon receiving the grants, nodes 102-104 cache the grants locally thereat (step 303). Over time, policy engine 101 may send updates adding grants, modifying existing grants, or removing existing grants and nodes 102-104 may update their cached grants accordingly.

In this example, source node 102 transmits packets directed for application 131 to destination node 103 over private network 105 (step 304). Upon receiving the packets, destination node 103 (i.e., private network client 132) determines the packets satisfy at least one of the grants (step 305). For example, at least one grant lists source node 102, destination node 103, a port used by the packets, and a protocol used by the packets as being allowed. The packets are, therefore, allowed to pass to application 131. If the packets did not satisfy any of the grants, then the packets would be discarded or otherwise not allowed to pass to application 131. In other examples, since all of nodes 102-104 receive and cache the grants, source node 102 (specifically a private network client executing thereat) may determine that the packets do not satisfy a grant prior to sending the packets to destination node 103.

Since the packets are passed to application 131 but application 131 requires authentication before handling the packets, application 131 requests authentication from private network client 132. Private network client 132 determines that a grant lists source node 102 as being allowed to access application 131 (step 306). To that end, private network client 132 responds to application 131 with an indication that application 131 is allowed to handle the packets from source node 102. Upon receiving the response, application 131 handles the packets (step 307). Handling of the packets may include application 131 sending packets back to source node 102. Those packets may similarly be processed at source node 102 to ensure a grant allows the packets being sent from destination node 103 to source node 102.

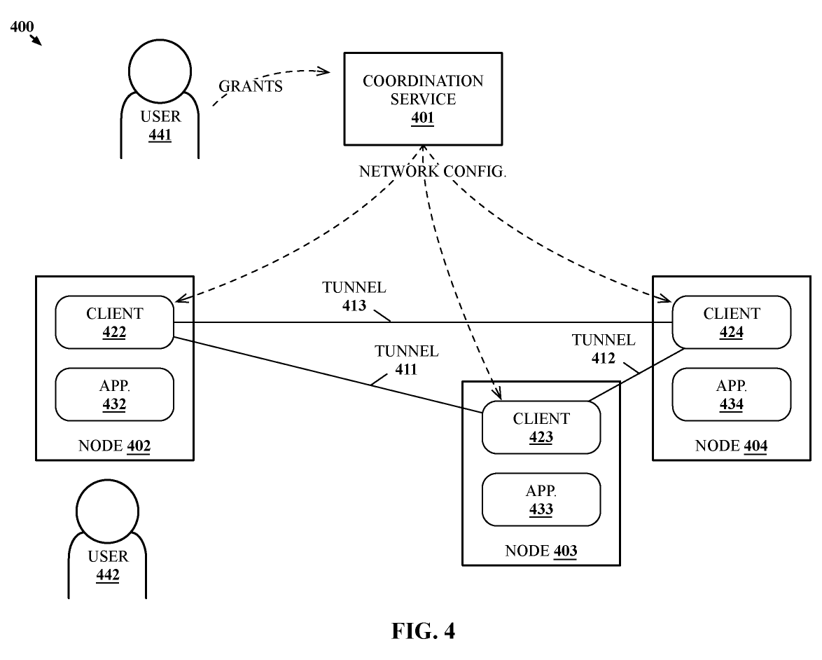

FIG. 4 illustrates implementation 400 for using grants to control access on a private network. Implementation 400 includes coordination service 401 and nodes 402-404. Coordination service 401 is a computing system performing control plane functions for a private network between nodes 402-404. Coordination service 401 distributes network configuration information to nodes 402-404, which nodes use to establish secure connectivity. The configuration information may include private Internet Protocol (IP) addresses for nodes 402-404, public IP addresses for nodes 402-404, encryption keys for nodes 402-404, or other parameters useful for creating a secure private network. In some examples, the configuration information may further include routing policies, posture requirements, or metadata for enforcing zero-trust principles. Coordination service 401 enables nodes 402–404 to create secure tunnels 411-413 over public network infrastructure using encapsulation and encryption protocols such as WireGuard or IPsec. Coordination service 401 also distributes access grants to nodes 402-404 to provide fine-grained control over communications within the private network. In other examples, coordination service 401 may revoke or update grants dynamically in response to policy changes, posture evaluations, or expiration conditions defined in the grants.

Each of nodes 402-404 executes a respective one of clients 422-424 to handle control plane communications with coordination service 401, maintain tunnels 411-413, exchange packets over the private network, and perform other tasks related to connectivity. Clients 422-424 may also perform cryptographic operations, such as encrypting and decrypting packets, encapsulating packets for transmission, and validating integrity of received packets. Since clients 422-424 operate within the communication path, they enforce access controls defined by grants received from coordination service 401. Enforcement may occur before packets are transmitted, after packets are received, or both, depending on whether the client acts as a source or destination. A network administrator, such as user 441, may define a grant through coordination service 401, which then distributes the grant to applicable clients 422-424. Grants may specify permissions at both the network layer (e.g., which nodes can communicate) and the application layer (e.g., which services or APIs can be accessed), enabling unified policy enforcement.

Clients 422-424 regulate the transmission of packets between respective applications 432-434, although nodes 402-404 may execute multiple applications concurrently. In this example, node 402 is a user system operated by user 442. Nodes 403 and 404 may also be user systems or other types of computing systems, such as servers, virtual machines, IoT devices, or containerized workloads. In some implementations, coordination service 401 may operate in a distributed manner across multiple computing systems for scalability and fault tolerance. Alternative embodiments may integrate coordination service 401 with an identity provider or public key infrastructure to validate user identities and rotate encryption keys. Grants may include additional conditions, such as device posture checks or time-based expiration, and clients 422-424 may periodically refresh cached grants to maintain compliance with evolving policies.

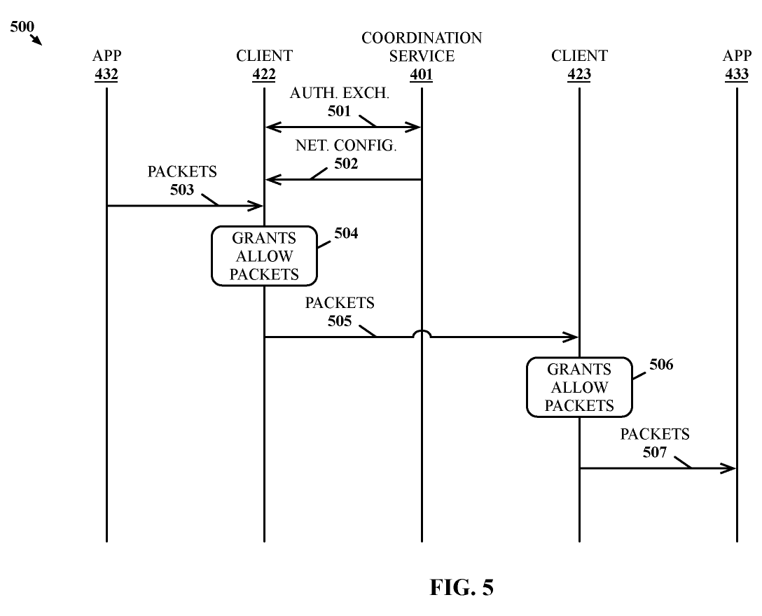

FIG. 5 illustrates operational scenario 500 for using grants to control access on a private network. In operational scenario 500, client 422 exchanges communications with coordination service 401 to authenticate itself and join the private network (step 501). Authentication may involve client 422 providing credentials directly to coordination service 401 or being redirected to an identity provider for verification. Credentials may include username-password pairs, cryptographic tokens, certificates, or ephemeral keys. In this example, credentials for user 442 are used to authenticate client 422, but other credential types may be employed in different implementations, such as OAuth tokens or hardware-backed keys. Once coordination service 401 determines that client 422 is authorized, coordination service 401 transmits network configuration information to client 422 (step 502). This configuration may include private IP addresses for nodes 403 and 404, public IP addresses for nodes 403 and 404, encryption keys, routing metadata, and posture requirements for compliance. In some examples, coordination service 401 may also push updated configuration data to clients 423 and 424 already connected to the private network to ensure seamless communication with node 402. The configuration information includes access grants that define permissions for network-layer and application-layer interactions. The access grants are cached at the client for quick access without having to query coordination service 401. Although client 422 may query coordination service 401 to apply the grants in some examples.

After joining the private network, application 432 generates one or more packets for transmission to node 403 (step 503). These packets may represent a request for data from application 433, a command to initiate a session, or any other type of message exchanged between applications. In this example, client 422 detects that the packets are directed to a private IP address (e.g., as opposed to an address outside of the private network) and references cached access grants to determine whether transmission is permitted (step 504). For instance, an access grant may specify that user 442, associated with client 422, is allowed to communicate with client 423 and may further define which applications at node 403 can be accessed. In alternative embodiments, grants may include additional conditions such as time-based validity or device posture checks, requiring client 422 to verify compliance before sending packets.

Client 422 transmits the packets over tunnel 411 to client 423 (step 505). The packets may be encrypted and encapsulated using protocols such as WireGuard or IPsec to ensure confidentiality and integrity during transit. Upon receiving the packets, client 423 evaluates whether the packets comply with the access grants (step 506). In some implementations, client 423 may assume compliance based on enforcement at the source node, while in others, client 423 performs its own validation for defense-in-depth. Grants may explicitly authorize forwarding packets to application 433, enabling application-layer control beyond simple network connectivity. This capability allows administrators to define granular permissions, such as permitting access to a database service but denying access to administrative APIs. Once client 423 confirms authorization, client 423 passes the packets to application 433 for processing (step 507). In many cases, the same grants enable bidirectional communication, allowing application 433 to respond to application 432 over the private network. Alternative implementations may include periodic revalidation of grants or dynamic updates from coordination service 401 to reflect changing policies or user roles.

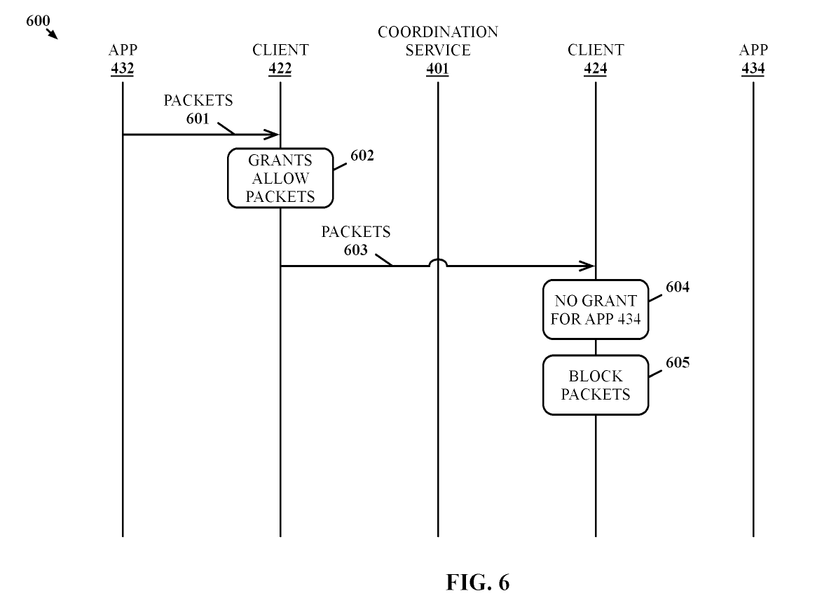

FIG. 6 illustrates an operational scenario for using grants to control access on a private network. Operational scenario 600 occurs after coordination service 401 distributes access grants to clients 422 and 424 after authenticating the nodes and establishing tunnels for private network connectivity (e.g., after steps 501 and 502 of operational scenario 500). In this example, application 432 generates one or more packets for transmission to node 404 (step 601). These packets may represent a request for data from application 434, a command to initiate a session, or any other type of message exchanged between applications. Client 422 detects that the packets are directed to a private IP address and references cached access grants to determine whether transmission is permitted (step 602). In this example, based on the information about the packets available to client 422, client 422 identifies a grant that allows the packets to be sent over the private network to client 424 at node 404.

Client 422 transmits the packets over tunnel 413 to client 424 (step 603). The packets may be encrypted and encapsulated using protocols such as WireGuard or IPsec to ensure confidentiality and integrity during transit. Upon receiving the packets, client 424 evaluates whether the packets comply with the access grants (step 604). In this example, client 424 recognizes that there is no grant allowing the packets to reach application 434 and blocks the packets accordingly (step 605). Client 422 may not have been able to identify characteristics of the packets that indicate they were destined for application 434. This may be the reason for client 422 not blocking the packets before transmission. In other examples, client 422 may recognize the application(s) associated with packets and apply the grants to that knowledge to block the packets prior to transmitting.

In some examples, blocking the packets may involve silently discarding the packets, while in others, client 424 may generate an error response or log the denial for auditing and compliance purposes. Alternative embodiments may include proactive enforcement at the source node, reducing unnecessary traffic across the private network. Grants may also include additional conditions such as device posture or time-based validity, requiring clients to verify compliance before allowing communication. For example, if node 402 fails a posture check or the grant has expired, either client 422 or client 424 may block the packets regardless of network-layer permissions. In other examples, coordination service 401 may dynamically update grants to reflect changes in user roles or application availability, and clients 422 and 424 may periodically refresh cached grants to maintain alignment with current policies.

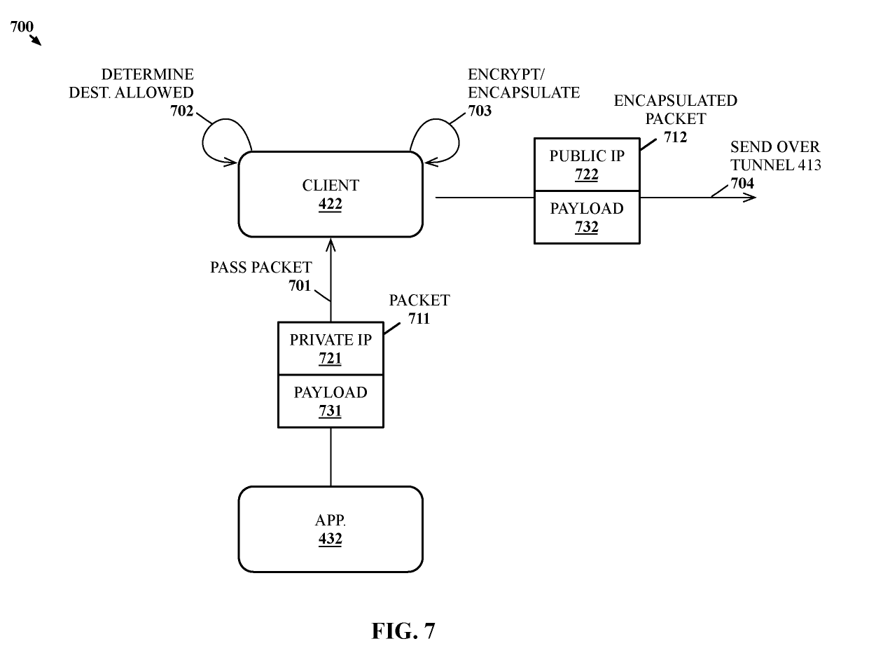

FIG. 7 illustrates operational scenario 700 for using grants to control access on a private network. Operational scenario 700 is an example of how client 422 and application 432 of node 402 may transmit packets over the private network. Application 432 generates packet 711 with payload 731 and a destination private IP address 721 in its header. The header may also include a private IP address of source node 402 (or the source private IP address may be added by client 422) or any other information in designated header fields of packet 711 (e.g., as specified by IPv4 or IPv6). Application 432 passes packet 711 to client 422 (step 701).

Client 422 determines a grant allows packet 711 to be transmitted to private IP address 721 over the private network (step 702). Client 422 may determine characteristics from packet 711, such as information in the header (e.g., private IP address 721, a source IP address assigned to client 422, or other header fields) and/or information about the payload (e.g., the application that generated the payload, the application to which the payload is being sent, etc.). Client 422 may further determine characteristics external to the packet, such as time of day, a location of node 402, or other posture-related information. In some examples, grants may include posture conditions requiring verification before transmission. Client 422 applies access grants to the determined characteristics to ensure an access grant explicitly allows the characteristics. If a given characteristic is not addressed in the grant, client 422 may assume that characteristic is not applicable. For instance, if a grant only lists network-layer characteristics, then all application-layer characteristics may be assumed allowable under the grant. In other examples, grants may include explicit application-layer permissions, requiring client 422 to confirm the originating application is authorized before transmission.

To transmit the allowed packet 711 over the private network, client 422 encrypts packet 711 into payload 732 of encapsulated packet 712 (step 703). Client 422 uses a public encryption key corresponding to private IP address 721 and then uses public IP address 722 corresponding to private IP address 721 in the destination address field of the header of encapsulated packet 712. The key and address correspondences are provided by coordination service 401 in the network configuration information. In some implementations, coordination service 401 may also provide ephemeral keys for short-lived sessions to enhance security. The configuration information may further include user identity mappings, enabling grants to reference users rather than device addresses. Thus, client 422 can resolve addresses corresponding to a user to determine whether a packet is associated with that user. Before encrypting and encapsulating packet 711, client 422 may verify posture conditions such as operating system version or security patch compliance. If posture requirements are not met, client 422 blocks the packet rather than transmitting it.

Encapsulated packet 712 is transmitted over the public network to public IP address 722 of node 404 (step 704). The encapsulation is what enables tunnel 413. In alternative embodiments, encapsulation may include additional metadata for routing or posture verification, and encryption may use algorithms negotiated during the initial authentication exchange. Some implementations may also support multi-hop routing through intermediate nodes, where grants specify permitted paths for traffic.

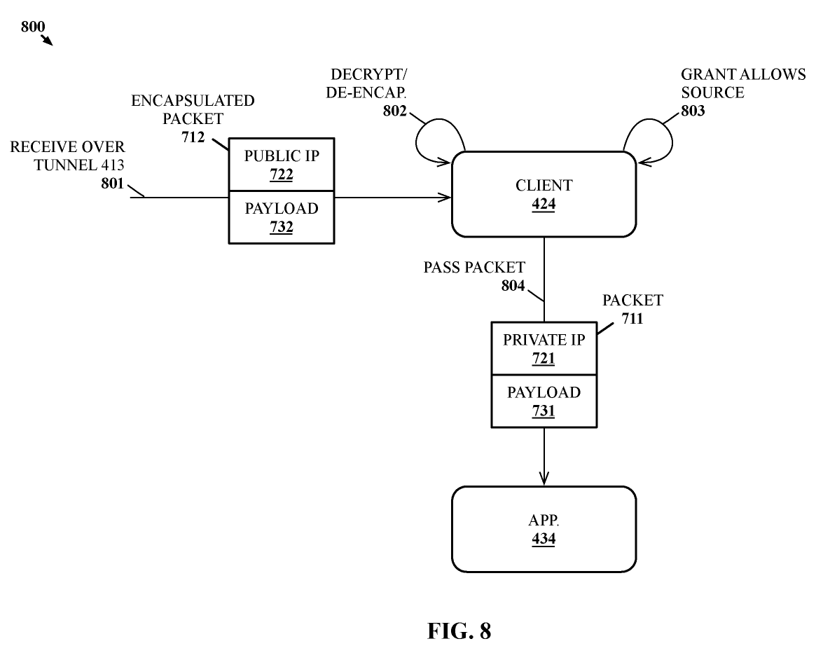

FIG. 8 illustrates operational scenario 800 for using grants to control access on a private network. Client 424 receives encapsulated packet 712 over tunnel 413 from node 402 (step 801). Client 424 decrypts payload 732 to restore packet 711 from encapsulated packet 712 (step 802). Client 424 uses a private encryption key corresponding to the public key client 422 used to encrypt payload 732. In some examples, the decryption process may also validate integrity using cryptographic signatures or message authentication codes to ensure the packet was not altered in transit. In some implementations, grants may include routing constraints requiring packets to traverse specific intermediate nodes or exit nodes. Client 422 may encapsulate packets with metadata indicating the required route, and client 424 may validate that the packet followed the authorized path.

In this example, client 424 confirms that a grant allows packets from node 402 as the source to node 404 as the destination (step 803). The grant may indicate the source/destination nodes allowed by public IP addresses, private IP addresses, users associated with the nodes, user groups associated with the nodes, or other identifying information. In alternative embodiments, grants may include additional conditions such as device posture, time-based validity, or routing constraints, requiring client 424 to verify compliance before forwarding the packet. For instance, if node 402 does not meet posture requirements (e.g., running an approved software version), client 424 may block the packet even if network-layer permissions exist.

In some examples, client 424 may further determine a grant allows packets from node 402 to reach application 434, allows the current device posture of node 402, and/or allows other characteristics associated with packet 711. This enables application-layer enforcement beyond simple connectivity, such as permitting access to a database service while denying access to administrative APIs. After determining packet 711 is allowed to reach application 434, client 424 passes packet 711 to application 434 (step 804). In other implementations, client 424 may log the decision for auditing purposes or periodically revalidate grants to ensure compliance with dynamic policies. Alternative designs may also support multi-hop routing, where client 424 checks whether intermediate nodes were authorized per the grant before accepting the packet.

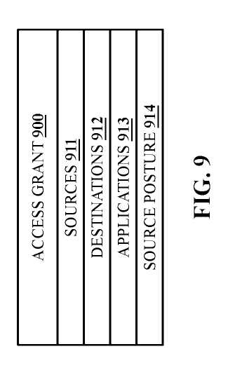

FIG. 9 illustrates access grant 900 for controlling access on a private network. Access grant 900 lists one or more sources 911, one or more destinations 912, one or more applications 913, and one or more aspects of source posture 914. Some of the lists are optional. For instance, a grant may apply only to network-layer characteristics of packet traffic, in which case application-layer characteristics would be omitted. In some examples, the grant may allow access to application 434 only for specific capabilities, such as read-only queries, while denying administrative actions. Client 424 enforces these granular permissions before passing packet 711 to application 434.

Sources 911 can include private or public IP addresses of nodes, hostnames, fully qualified domain names, user identities such as email addresses, user groups like “group:engineering” or “group:analytics,” device tags such as “tag:frontend” or “tag:database,” roles or autogroups like “autogroup:admin” or “autogroup:member,” CIDR ranges for subnets, ephemeral node identifiers, and logical selectors such as posture-based conditions.

Destinations 912 can include private or public IP addresses, hostnames or aliases, user identities, tags representing services or clusters such as “tag:internal-tools” or “tag:k8s-operator,” application connectors, virtual machines, containerized workloads, IP sets like “ipset:prod-infra,” and even geographic or network segments for segmentation policies.

Applications 913 can include specific services or capabilities such as “tailscale.com/cap/tailsql” for database access, “tailscale.com/cap/secrets” for secret management, or “tailscale.com/cap/kubernetes” for cluster control. Applications may also define granular permissions such as read-only access, query execution, or administrative actions, and may reference APIs, microservices, or SaaS endpoints integrated with the private network.

Source posture 914 can include operating system type and version, security patch level, presence of endpoint protection software, encryption status of local storage, hardware attributes like TPM presence, runtime checks such as container image hash validation, and device posture conditions defined in the grant (e.g., “posture:latestMac” requiring a latest macOS version). A single grant may list multiple applications, such as a database service and a monitoring API, allowing unified policy enforcement for related resources.

In addition to these lists, grants may specify network-layer characteristics such as allowed ports (e.g., “443,” “tcp:22,” “udp:53”), allowed protocols (e.g., “icmp:*,” “tcp:443”), port ranges (e.g., “80-443”), and routing constraints using “via” fields to enforce traffic through specific exit nodes or app connectors. Grants may also include time-based validity, expiration conditions, or dynamic posture checks, enabling fine-grained and adaptive access control across both network and application layers.

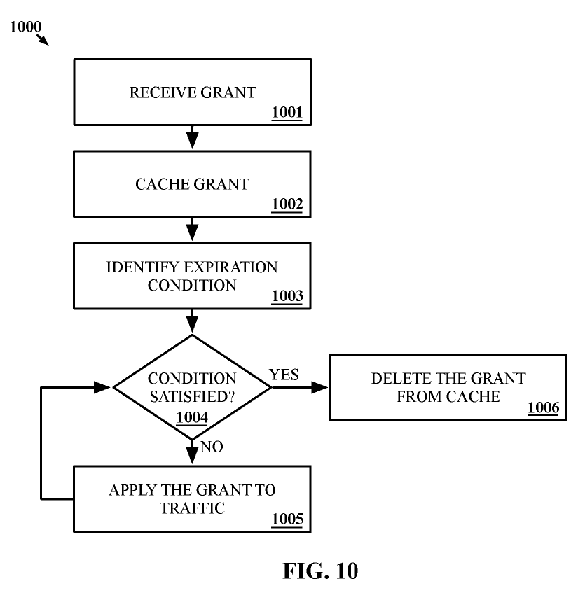

FIG. 10 illustrates operation 1000 that uses grants to control access on a private network. Operation 1000 is an example of how time-based validity may be implemented in node 402. Client 422 receives a grant from coordination service 401 (step 1001). The grant may be provided when client 422 joins the private network or at a later time, such as when coordination service 401 gives a user temporary access to a resource associated with the grant.

[Client 422 caches the grant with other grants controlling network access on the private network (step 1002). Client 422 further identifies an expiration condition specified in the grant (step 1003). Expiration conditions can take many forms. For example, a grant may expire after a fixed duration such as one hour, one day, or one week from issuance. In other cases, the expiration may be tied to a specific date and time, such as midnight on a given day or the end of a maintenance window. Expiration may also be event-driven, such as when a user logs out, disconnects from the private network, or completes a transaction. Other examples include posture-based expiration, where the grant becomes invalid if the device fails a compliance check, or session-based expiration, where the grant is removed after a VPN session ends.

As long as the expiration condition has not been satisfied (step 1004), client 422 continues to apply the grant to traffic exchanged over the private network (step 1005). When the condition is satisfied, client 422 deletes the grant from the cache, preventing the grant from being used on subsequent traffic (step 1006). In some implementations, client 422 may periodically check the expiration condition or receive updates from coordination service 401 to enforce dynamic policies. For example, coordination service 401 may revoke a grant early if a user’s role changes or if suspicious activity is detected. In other examples, expiration may involve cryptographic key rotation, where the grant becomes invalid once associated keys are replaced, ensuring that stale grants cannot be exploited. Other expiration conditions may include user logout, completion of a transaction, or detection of suspicious activity. These events may trigger immediate revocation of the grant by coordination service 401 or by client 422.

Operation 1000 is an example of how time-based validity may be implemented in node 402. Client 422 receives a grant from coordination service 401 (step 1001). The grant may be provided when client 422 joins the private network or at a later time (e.g., when coordination service 401 gives a user temporary access to a resource associated with the grant).

Client 422 caches the grant with other grants controlling network access on the private network (step 1002). Client 422 further identifies an expiration condition specified in the grant (step 1003). As long as the expiration condition has not been satisfied (step 1004), client 422 continues to apply the grant to traffic exchanged over the private network (step 1005). When the condition is satisfied, client 422 deletes the grant from the cache preventing the grant from being used on the traffic (step 1006).

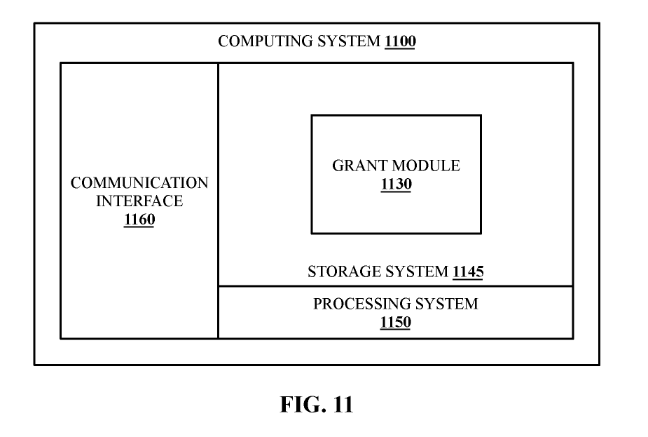

FIG. 11 illustrates computing system 1100 for using grants to control access on a private network. Computing system 1100 is representative of any computing system or systems with which the various operational architectures, processes, scenarios, and sequences disclosed herein can be implemented. Computing system 1100 is an example architecture for policy engine 101, nodes 102-104, although other examples may exist. Computing system 1100 includes storage system 1145, processing system 1150, and communication interface 1160. Processing system 1150 is operatively linked to communication interface 1160 and storage system 1145. Communication interface 1160 may be communicatively linked to storage system 1145 in some implementations. Computing system 1100 may further include other components such as a battery and enclosure that are not shown for clarity.

Communication interface 1160 comprises components that communicate over communication links, such as network cards, ports, radio frequency (RF), processing circuitry and software, or some other communication devices. Communication interface 1160 may be configured to communicate over metallic, wireless, or optical links. Communication interface 1160 may be configured to use Time Division Multiplex (TDM), Internet Protocol (IP), Ethernet, optical networking, wireless protocols, communication signaling, or some other communication format – including combinations thereof. Communication interface 1160 may be configured to communicate with other computing systems via one or more networks.

Processing system 1150 comprises microprocessor and other circuitry that retrieves and executes operating software from storage system 1145. Storage system 1145 may include volatile and nonvolatile, removable, and non-removable media implemented in any method or technology for storage of information, such as computer readable instructions, data structures, program modules, or other data. Storage system 1145 may be implemented as a single storage device but may also be implemented across multiple storage devices or sub-systems. Storage system 1145 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 1145, or any other computer-readable storage medium herein, be considered a transitory form of signal transmission (often referred to as "signals per se"), such as a propagating electrical or electromagnetic signal or carrier wave.

Processing system 1150 is typically mounted on a circuit board that may also hold the storage system. The operating software of storage system 1145 comprises computer programs, firmware, or some other form of machine-readable program instructions. The operating software of storage system 1145 comprises grant module 1130. The operating software on storage system 1145 may further include an operating system, utilities, drivers, network interfaces, applications, or some other type of software. When read and executed by processing system 1150 the operating software on storage system 1145 directs computing system 1100 to network routing advertisements as described herein. Grant module 1130 may execute natively on processing system 1150 or the operating software may include virtualization software, such as a hypervisor, to virtualize computing hardware on which grant module 1130 executes. Grant module 1130 may be a component of a client, like private network client 132, enabling computing system 1100 to communicate over a private network.

In at least one example, computing system 1100 is a destination node for packets exchanged over a private network. Grant module 1130 executes on processing system 1150 and directs processing system 1150 to receive a grant from a policy engine for a private network. The grant indicates a list of sources, a list of destinations the sources are allowed to access, and a list of applications. Grant module 1130 further directs grant module 1130 to cache the grant in a cache at computing system 1100. Computing system 1100 receives one or more packets over the private network from a source node. The one or more packets are directed towards an application executing on the destination node. In response to determining the source node is in the list of sources, the destination node is in the list of destinations, grant module 1130 directs processing system 1150 to pass the one or more packets to the application. Grant module 1130 also directs processing system 1150 to receive a request from the application asking whether the source node is allowed to access the application and, in response to accessing the grant in the cache to determine the source node is in the list of sources, the destination node is in the list of destinations, and the application is listed in the list of applications, respond to the request with an indication that the source node is allowed to access the application.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for coordinating permissions between nodes on a private network, the method comprising:
receiving a grant at a destination node of the nodes from a policy engine for the private network, wherein the grant indicates a list of sources and a list of destinations that sources in the list of sources are allowed to access;
caching the grant in a cache at the destination node;
receiving one or more packets over the private network from a source node, wherein the one or more packets are directed towards an application executing on the destination node; and
in response to accessing the grant from the cache to determine the source node is in the list of sources and the destination node is in the list of destinations, passing the one or more packets to the application.

2. The method of claim 1, comprising:
receiving one or more second packets over the private network from a second source node; and
in response to determining the second source node is not in the list of sources, blocking the one or more second packets.

3. The method of claim 2, wherein the grant is cached with a plurality of grants received by the destination node, and the one or more second packets are blocked in response to determining none of the plurality of grants allow the one or more second packets.

4. The method of claim 1, where in the grant further includes a list of applications, and the method comprising:
after passing the one or more packets to the application, receiving a request from the application asking whether the source node is allowed to access the application; and
in response to accessing the grant in the cache to determine the application is listed in the list of applications, responding to the request with an indication that the source node is allowed to access the application.

5. The method of claim 1, where in the grant further includes a list of applications, and wherein passing the one or more packets to the application also occurs in response to determining the application is listed in the list of applications.

6. The method of claim 1, wherein the grant is received and cached by each node included in either or both of the list of sources and the list of destinations.

7. The method of claim 1, comprising:
receiving an updated grant with an updated list of sources and an updated list of destinations;
replacing the grant in the cache with the updated grant;
receiving one or more second packets at the destination node over the private network from the source node; and
in response to accessing the updated grant from the cache to determine the source node is not in the updated list of sources, blocking the one or more second packets.

8. The method of claim 1, wherein the source node is identified as a user associated with the source node, and the method comprising:
determining a private network address of the source node on the private network corresponds to the user; and
determining the user is in the list of sources.

9. A method for coordinating permissions in a private network, the method comprising:
retrieving definitions for access grants, wherein the access grants provide permissions allowing nodes of the private network to communicate with others of the nodes specified by the access grants;
providing the access grants to the nodes; and
in the nodes, allowing communication exchanges over the private network between the nodes when permitted by the access grants.

10. The method of claim 9, wherein allowing the communication exchanges comprises:
in a source node of the nodes, identifying traffic for transmission over the private network to a destination node of the nodes; and
in response to determining at least one of the access grants permits the source node to transmit communications to the destination node, transmitting the traffic over the private network.

11. The method of claim 9, wherein allowing the communication exchanges comprises:
in a source node of the nodes, identifying traffic for transmission over the private network to a destination node of the nodes; and
in response to determining that permission for the source node to transmit communications to the destination node is not included in the access grants, denying transmission of the traffic over the private network.

12. The method of claim 9, wherein allowing the communication exchanges comprises:
in a destination node of the nodes, receiving traffic transmitted over the private network from a source node of the nodes; and
in response to determining at least one of the access grants permits the source node to transmit communications to the destination node, passing the traffic to an application at the destination node.

13. The method of claim 9, wherein allowing the communication exchanges comprises:
in a source node of the nodes, identifying traffic for transmission over the private network to a destination node of the nodes, wherein the traffic is generated by an application executing on the source node; and
in response to determining at least one of the access grants permits the application to transmit communications to the destination node, transmitting the traffic over the private network.

14. The method of claim 9, wherein allowing the communication exchanges comprises:
in a source node of the nodes, encapsulating packets directed to a private network address of a destination node of the nodes upon determining at least one of the access grants permits transmission of the packets to the destination node; and
transmitting encapsulated packets resulting from the encapsulating to a public network address of the destination node.

15. The method of claim 14, wherein encapsulating the packets comprises:
encrypting packets for inclusion in payloads of the encapsulated packets using a public encryption key associated with the destination node, wherein the destination node uses a private key thereat to decrypt the payloads.

16. The method of claim 9, comprising:
at node of the nodes, determining a grant of the access grants includes an expiration condition; and
removing the grant from the access grants at the node upon satisfaction of the expiration condition.

17. The method of claim 9, comprising:
identifying traffic directed to a destination node of the nodes from a source node of the nodes;
before permitting the traffic, determining device posture for one or both of the destination node and the source node does not satisfy a grant of the access grants; and
blocking the traffic in response to determining the device posture does not satisfy the grant.

18. An apparatus for coordinating permissions in a private network, the apparatus comprising:
one or more computer readable storage media;
a processing system operatively coupled with the one or more computer readable storage media; and
program instructions stored on the one or more computer readable storage media that, when read and executed by the processing system, direct the apparatus to:
execute a client for communicating over the private network;
receive access grants from a coordination service of the private network, wherein the access grants define allowed characteristics of communications permitted over the private network;
identify private-network traffic;
allow a first portion of the private-network traffic having first characteristics of the allowed characteristics; and
deny a second portion of the private-network traffic having second characteristics absent from the first characteristics.

19. The apparatus of claim 18, wherein the allowed characteristics include application-layer characteristics and network-layer characteristics.

20. The apparatus of claim 18, wherein the program instructions direct the apparatus to:
receive updated access grants from the coordination service; and
allow a subset of the second portion of the private-network traffic permitted by the updated access grants.
